(19) United States
(12) Patent Application Publication
(10) Pub. No.: US 2012/0228571 A1
(43) Pub. Date: Sep. 13, 2012

(54) ADVANCED ROLLING ELEMENT BLOCK

(76) Inventor: Donald Butler Curchod, Avalon (AU)

(21) Appl. No.: 13/510,007

(22) PCT Filed: Nov. 16, 2010
(86) PCT No.: PCT/AU2010/001538

§ 371 Date: May 16, 2012

Related U.S. Application Data
(60) Provisional application No. 61/261,710, filed on Nov. 16, 2009.

(51) Int. Cl. B66D 3/04

(52) U.S. Cl. 254/416

(57) ABSTRACT

A block has a sheave (4) mounted for rotation about an axis with first bearing elements (6a, 6b) that transfer both axial and radial loads and second bearing elements (12) that transfer both radial loads, so increasing load capacity.

### TECHNICAL FIELD

Blocks with sheaves mounted for rotation about an axis are used on yachts and other sea going vessels. The blocks are typically exposed to sea water, sand and other contaminants.

The invention relates to a rolling element block with improved load bearing and efficiency with minimal increase in overall weight and an improved connection, leading to lower cost and weight compared to existing blocks with similar load bearing capacity.

### BACKGROUND ART

Rolling element blocks have used sheaves having parallel sides, the width of these sheaves having the minimum width possible for a given single rope groove size, increased loads being obtained by increasing the diameters.

These blocks fall into two categories:

The first category is a ball bearing block having two rows of ball bearings set on either side of the block centerline. These blocks rely on the balls to take both the radial and axial loads applied to the block

The second category is a roller bearing block with a central row of rollers and two side rows of balls. Both rollers and balls fall almost entirely possible width commensurate with the size of the rope groove.

These blocks also utilize various methods of connection to a load point.

Tapered roller bearings are not a practicable option for taking of both axial and radial loads in blocks used on sea going vessels due to their cost, precision required and contamination by sand, salt and other contaminants. Accordingly, the aim of embodiments of the invention is to provide an improved block that does not utilize tapered roller bearings.

One aim of embodiments of the invention is to significantly increase the load bearing capacity of rolling element blocks while allowing higher efficiency, by increasing bearing area and at the same time providing a simpler connection without significantly increasing size, cost, or weight of the block.

### SUMMARY OF THE INVENTION

In one broad form the invention provides a block having a sheave mounted for rotation about an axis on a first race, the sheave having a sheave race and a peripheral circumferentially extending groove for receiving a flexible tension member, the sheave having a sheave width and the groove having a groove width, the sheave race including

two spaced apart first surfaces that engage first rolling elements located between the sheave race and corresponding second surfaces on the first race

and at least one third surface that engages second rolling elements located between the sheave race and corresponding fourth surfaces the first race, wherein
A) the first and second surfaces are shaped so the first rolling elements transfer both axial and radial loads between the sheave race and the first race, and the third and fourth surfaces are shaped so the second rolling elements transfer radial loads between the sheave race and the first race, or
B) the ratio of:

B1)sheave width to groove depth is equal to or more than about 2.5:1, or

B2)sheave diameter to sheave width is less than about or equal to 3.2:1, or

B3)the ratio of sheave width to groove depth is equal to or more than about 2.5:1 and the ratio of sheave diameter to sheave width is less than about or equal to 3.2:1,

or
C) the first and second surfaces are shaped so the first rolling elements transfer at least axial loads between the sheave race and the first race, and the third and fourth surfaces are shaped so the second rolling elements transfer radial loads between the sheave race and the first race, and

the ratio of:

C1) sheave width to groove depth is equal to or more than about 2.5:1, or

C2) sheave diameter to sheave width is less than about or equal to 3.2:1, or

C3) the ratio of sheave width to groove depth is equal to or more than about 2.5:1 and the ratio of sheave diameter to sheave width is less than about or equal to 3.2:1.

The at least one first surface may include a first portion extending generally parallel to the axis and a second portion extending generally perpendicular to the axis.

The second portion may extend radially inwards from the first portion.

The second portion may extend radially outwards from the first portion.

The third surface may include a third portion extending generally parallel to the axis.

The at least one first surface and corresponding second surface may comprise parallel surfaces extending at an angle to the axis. Non tapered roller bearings may be used as the first rolling elements. The angle of the at least one first surface to the axis may be up to about 30 degrees.

The third surface may be located between the two first surfaces.

At least one line extending perpendicular to the axis may pass through the third surface and a first surface, i.e. the third surface and a first surface may overlap.

The third portion may have a width substantially equal to the sheave width.

The first and second surfaces may be contiguous.

The third portion may be located radially inwards compared to a first portion.

The second rolling elements may be located radially inwards compared to the first rolling elements.

The second rolling elements may include at least two parallel sets of rolling elements.

The first rolling elements may be located substantially within the groove width.

The first rolling elements may extend significantly beyond the groove width, i.e. more than just the clearance width.

The center of each first rolling element may be located substantially outside the groove width.

The first rolling elements may be located substantially outside the groove width.

The first rolling elements may comprise ball bearings or non tapered roller bearings.

The second rolling elements may comprise ball bearings, roller bearings or both ball bearings and roller bearings. In preferred implementations the roller bearings are non tapered.

The ratio of sheave width to groove depth may be greater or equal to about 4:1.

The second rolling elements may comprise a single line of non tapered roller bearings. These may have a length substantially the same as the sheave width.

The first and second surfaces may be shaped so the first rolling elements only transfer radial loads between the sheave race and the first race.

The first and second surfaces may be shaped so the first rolling elements transfer both axial and radial loads between the sheave race and the first race.

The third and fourth surfaces may be shaped so the second rolling elements only transfer radial loads between the sheave race and the first race.

An advantage of at least one implementation of the present invention is to provide a ball bearing block for a single line, having an additional row or rows of central balls in addition to the traditional outer balls, which carry both radial and side loads. Said central balls carrying radial loads, provide a block similar in size cost and weight to a traditional block but have significant extra radial load capacity and efficiency.

Another advantage of at least one implementation of the present invention is to provide a ball bearing block for a single line, having an additional row or rows of central rollers in addition to the traditional outer balls. With said central rollers carrying radial loads, it provides a block similar in size cost and weight to a traditional block but having significant extra radial load capacity and efficiency.

Another advantage of at least one implementation of the present invention is to provide a roller bearing block for a single line, with the sheave of said block having a slight increase in width compared to the groove width. This allows rollers to be wider, enabling said rollers to carry additional radial loads, providing a slightly wider block than a traditional block but having significant extra radial load capacity and efficiency for a slight increase in cost and weight.

An additional advantage of at least one implementation of the present invention is to provide a roller bearing block with the sheave of said block having an increase in width compared to the groove width having the two outer rows of ball bearings carrying side loads as well as carrying additional radial loads. This provides a block with a slight increase in width cost and weight to a traditional block to have significant extra radial load capacity and efficiency.

A further advantage of at least one implementation of the present invention is to provide an improved roller bearing block with a simpler, light weight rope connection.

Another advantage of at least one implementation of the invention is to provide lubricating plastic dividers between some of the rolling element balls and or rollers to reduce the friction and enhance the efficiency of the block.

The foregoing features of the invention may be combined in any combination of features where features are not mutually exclusive.

Unless the context clearly requires otherwise, throughout the description and the claims the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF THE DRAWINGS

FIG. shows an existing prior art ball bearing block section;

FIG. 2 shows an existing prior art roller bearing block section;

FIG. 3 shows a ball bearing block section with extra load capacity;

FIG. 3a shows a ball bearing block section with extra load capacity compared to block of FIG. 3;

FIG. 4 shows a ball roller bearing block section with extra load capacity, as well as an improved rope connection;

FIG. 4a shows a ball roller bearing block of FIG. 4 with an alternate rope loop;

FIG. 5 shows a rolling element bearing block section with extra width and extra load capacity rollers;

FIG. 6 shows a rolling element bearing block section with extra width and extra load capacity rollers and balls, as well as an improved rope connection;

FIG. 6a shows a further arrangement rolling element bearing block section with extra width and extra load capacity rollers and balls;

FIG. 6b shows a cross section of an alternative roller bearing block according to the present invention;

FIG. 7 shows a sectioned ball bearing row with ball lubricating element; and

FIG. 7a shows a sectioned roller bearing row with roller lubricating element.

### DETAILED DESCRIPTION OF THE INVENTION

FIGS. 1 & 2 show sections of single line prior art blocks. FIG. 1 has sides 5a and 5b, sheave 3 has two rows of balls 1a and 1b carrying both radial and side loads. Typically sheave width 9 to groove depth 7 is approximately 1.3:1.

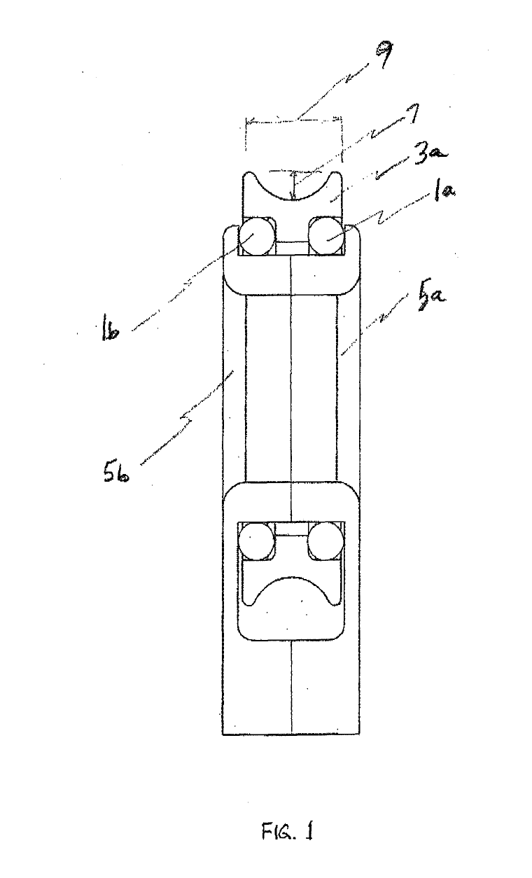

Prior art block of FIG. 2 has sides 15a and 15b and sheave 11 with rollers 21 which take radial loads. Side balls 13a and 13b lie almost entirely within width 19 and said side balls take only side loads. Typically also this block has a width 19 to groove depth 17 approximately 1.3:1.

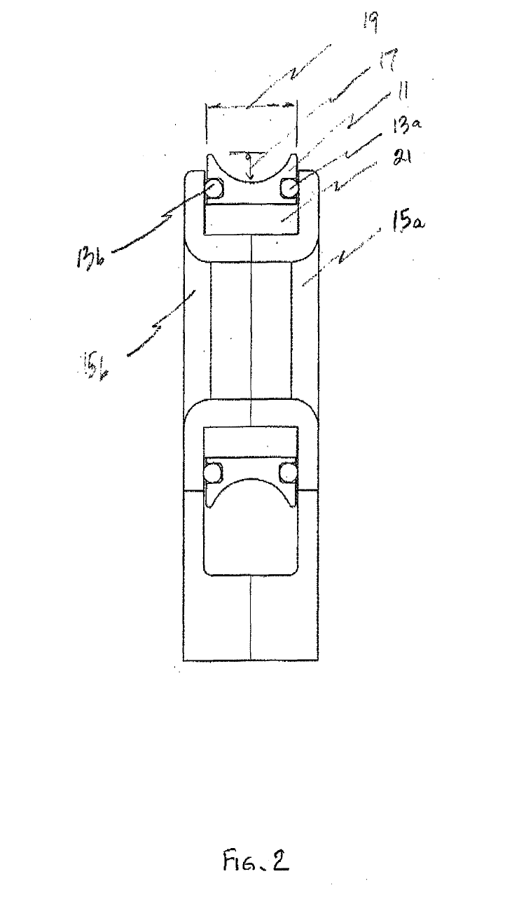

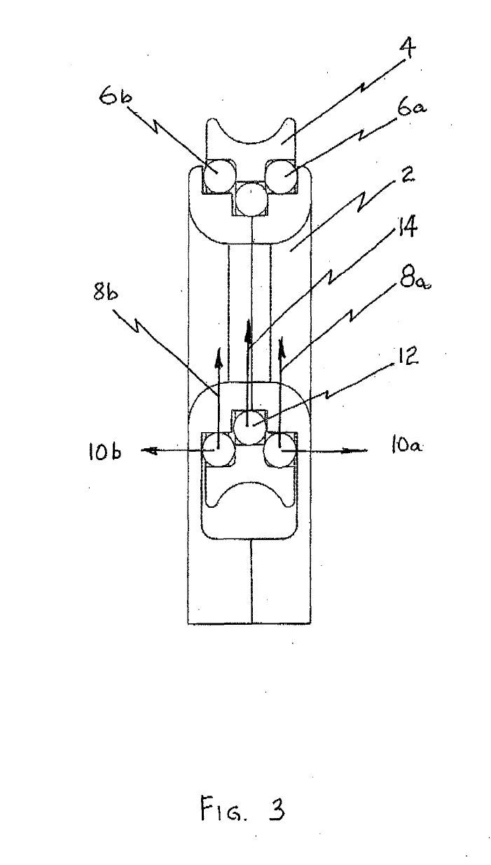

FIG. 3 shows a cross section of a single line ball bearing block according to the present invention with traditional body 2, sheave 4 with side balls 6a and 6b where said side balls carry radial loads shown by arrows 8a and 8b as well as side loads 10a and 10b. Also shown is an additional row of balls 12, which allow the block to take additional radial loads 14, within a similar sized block, compared to existing ball bearing block of FIG. 1.

FIG. 3a shows a cross section of a single line ball bearing block according to the present invention similar to that of FIG. 3 with traditional body having sides 23a and 23b, sheave 21 with side balls 33a and 33b where said side balls carry radial loads shown by arrows 41a and 41b as well as side loads 43a and 43b. This block has an additional two rows of balls 25a and 25b, which allow the block to take additional radial loads 45a and 45b, within a slightly wider block, compared to existing ball bearing block of FIG. 1. Central balls are separated by divider 27, which may be integral with sheave 21 or a separate washer.

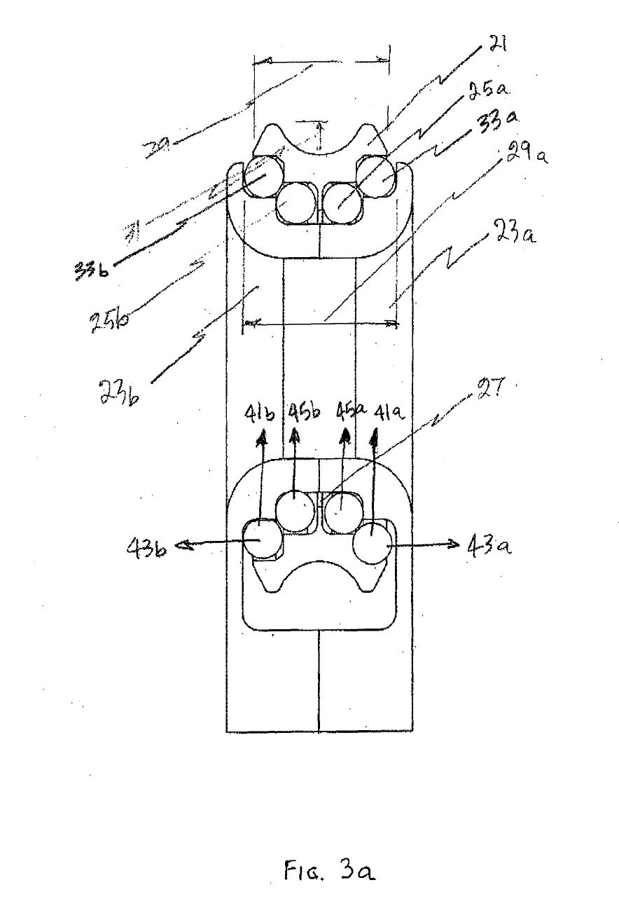

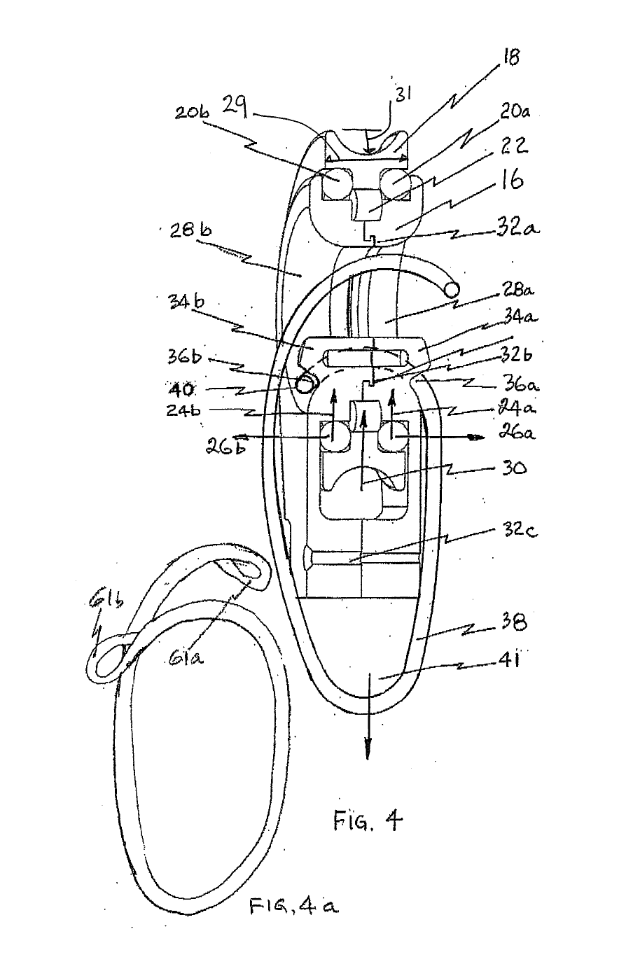

FIG. 4 shows a cross section of a single line ball bearing block according to the present invention with body 16, side balls 20a and 20b carrying both radial loads 24a and 24b as well as side loads 26a and 26b, as well as additional central row of rollers 22 carrying additional significant radial loads 30 within a similar sized block, compared to that of the ball bearing block of FIG. 1. The ratio of widths 29 and 29a to depth of groove 31 is significantly greater than the corresponding ratio of the block of of FIG. 1, with ratio of width 9 to groove depth 7, which has a ratio of approximately 1.3:1.

FIG. 4 also shows body 16 having sides 28a and 28b with connection points 32a 32b and screw connection 32c. Sides 28a and 28b have posts 34a and 34b, forming shoulders 36a and 36b. Cross section of a loop 38 is shown with one end of loop 38 hooked over shoulder 34b at 40. Loop 38 passes through center of body 28 through load point 41 back through center of body 28 and across over opposite post 34a engaging opposing shoulder 34a at point 36a so as to provide a simple lightweight tensile connection between block and load point 41.

FIG. 4a shows an alternative loop with spliced ends 61a and 61b.

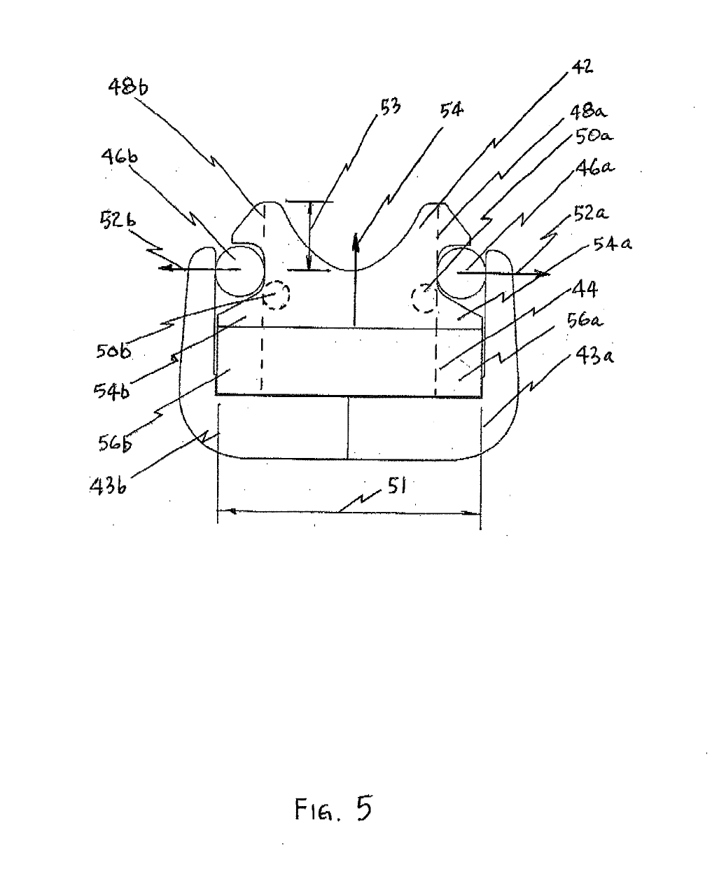

FIG. 5 shows a cross section of a single line roller bearing block according to the present invention having a traditional body formed by sides 43a and 43b, sheave 42 with roller 44 carry radial loads 54. Block has side balls 46a and 46b where said side balls carry side loads shown by arrows 52a and 52b. By way of comparison dotted lines 48a and 48b show the corresponding position of the parallel sides of the prior art block of FIG. 2 and 50a and 50b show the corresponding position of the side balls 13a and 13b of the prior art block of FIG. 2. The width of dotted lines to groove depth is usually about 2.1:1 whereas the width 51 of sheave 42 compared to groove depth 53 is approximately 4:1.

Block of FIG. 5 has an additional width of sheave shown at 54a and 54b and corresponding extra width of roller 44, shown at 56a and 56b. Extra width rollers at 56a and 56b allow the block of FIG. 5 to carry significantly more load compared to block with dotted lines 48 because of the extra width compared to existing blocks with similar groove sections and diameters.

The extra width can also be expressed with reference to sheave diameter. In one implementation the sheave has an outside diameter of about 80 mm, the groove depth is about 8 mm to 10 mm and the sheave has a width of about 25 mm, giving a ratio of sheave diameter to sheave width of about 3.2. This compares with prior art bocks in which the ratio of sheave diameter to sheave width is greater than about 3.75.

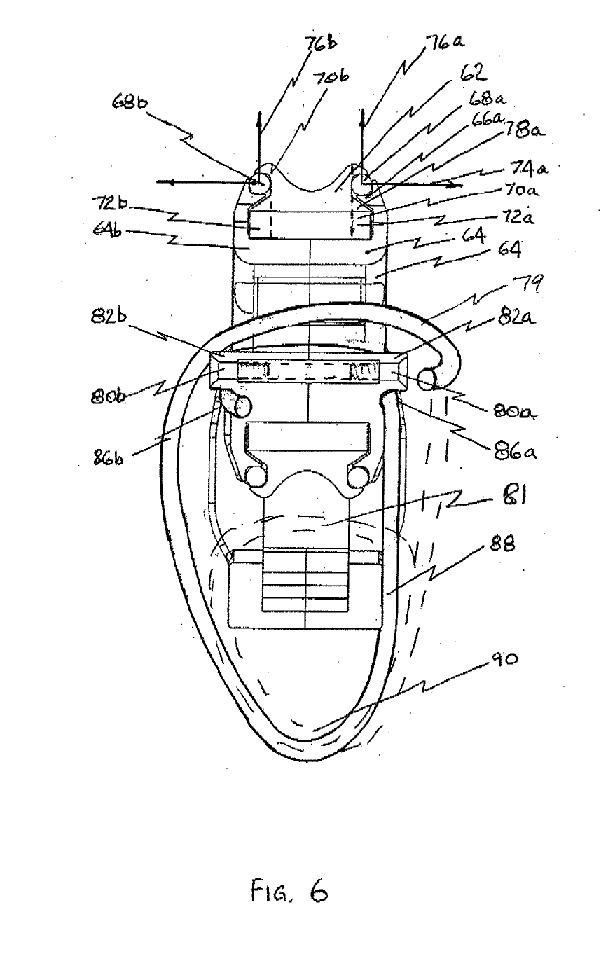

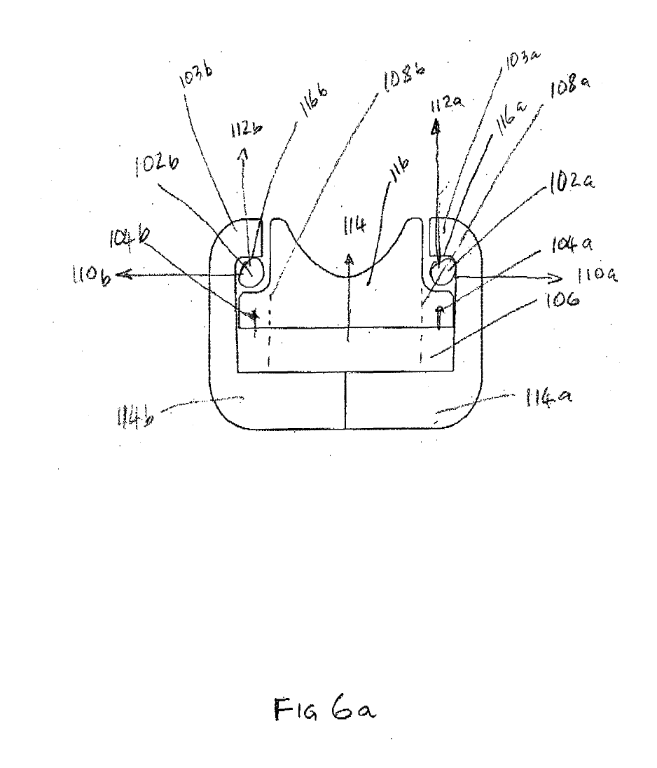

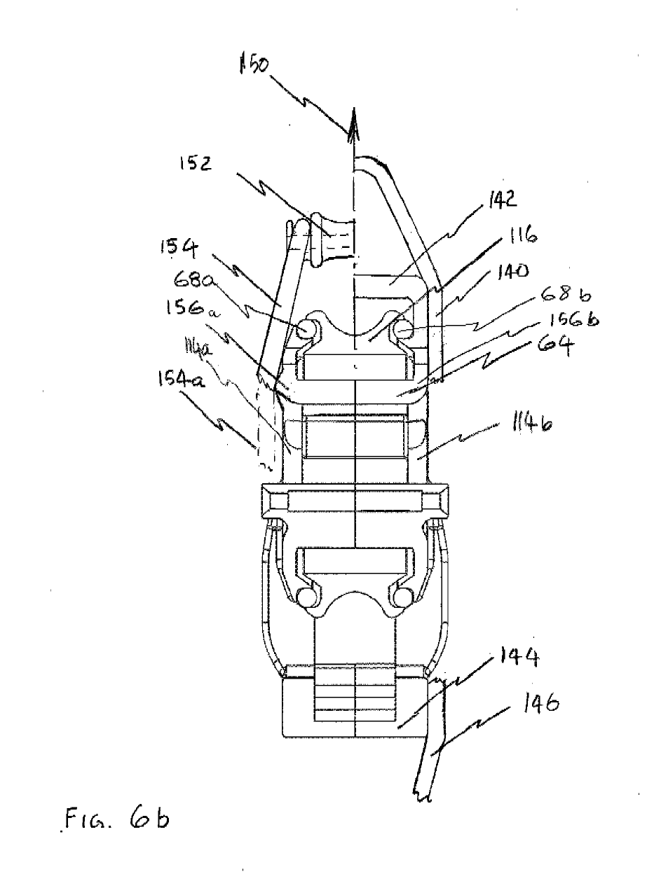

FIG. 6 shows a cross section of a roller bearing single line block according to the present invention which is similar to block of FIG. 5 having extra width 72a and 72b compared to existing block sheaves with width shown by the dotted lines 70a and 70b.

Sides 64a and 64b are arranged to have shoulders 66a and 66b engaging bottom of side balls 68a and 68b. Chamfered sheave has sides 78a and 78b, so that side balls 68a and 68b carry both side loads 74a and 74b as well as extra radial loads 76a and 76b without any extra width compared to block of FIG. 5. This provides a block with significant extra load carrying capacity and efficiency compared to the existing block of FIG. 2, with only slightly extra weight, cost and size.

FIG. 6 also shows connection screws 80a and 80b having shoulders 82a and 82b in sides 64a and 64b. Rope or flexible loop 8 has two ends. One end of the loop section 88 engages the underside of shoulder 82b at 86b then passes through the center of body 64 down the side of the block, at least once around the load bearing point 90, back though the center of the block, crossing over loop end 80b to engage shoulder 82a at 86a to form an easily connected and disconnected lightweight tensile connection which provides a distributed load to block center adding to screw connection 80. The overlapping connection loop 88 can take any form and is not limited to one pass through the block center.

Also shown in FIG. 6 is additional loop which in addition to passing at least once through the center of block at 79, also passes through the bottom opening at 81 to give additional distribution of loop load.

FIG. 6a shows a cross section of an alternative roller bearing block FIG. 6 with sheave section 116 and sides 114a and 114b with roller 106 and side balls 102a and 102b. Side balls 102a and 102b take side loads 110a and 110b, and extend past existing block sides shown by dotted lines 108a and 108b. Sides 114a and 114b extend past the balls and wrap back over balls 102a and 102b at 103a and 103b, bearing extra radial loads at 112a and 112b such that both balls 108a and 108b and extended rollers 106 and extended sheave 104a and 104b all simultaneously carry radial loads giving substantial increased load compared to just the load bearing between dotted lines 108a and 108b of an existing block.

FIG. 6b shows a cross section of two alternative roller bearing block according to the present invention with features similar to that of block of FIG. 6 with sheave section 116 and sides 114a and 114b, but with added becket loop 154. The figure is split along vertical centerline to show tow variations. On the right hand side of FIG. 6b a current becket block 140 is shown. In order for substantial becket load 150 not to compress sides and balls 68a and 68b, side must be extended upwards and a compression piece 142 employed in order for block to operate efficiently.

If the block is constructed as in left hand side of FIG. 6b, with becket loop 154 attaching to bobbin 152 which bobbin has sufficient width so that compression loads from becket 154 do not pinch sides but are absorbed by central portion of block at 156a and 156b then a lighter more advanced becket block is provided. It should be noted that becket loop 154 may pass through center of block or bypass block at 154.

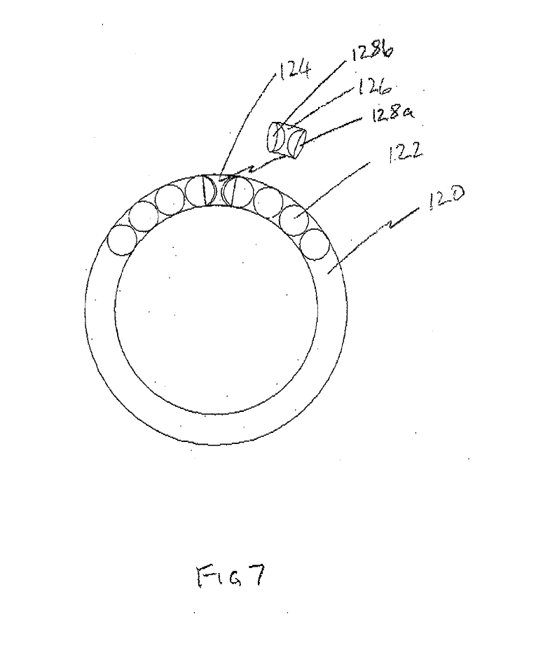

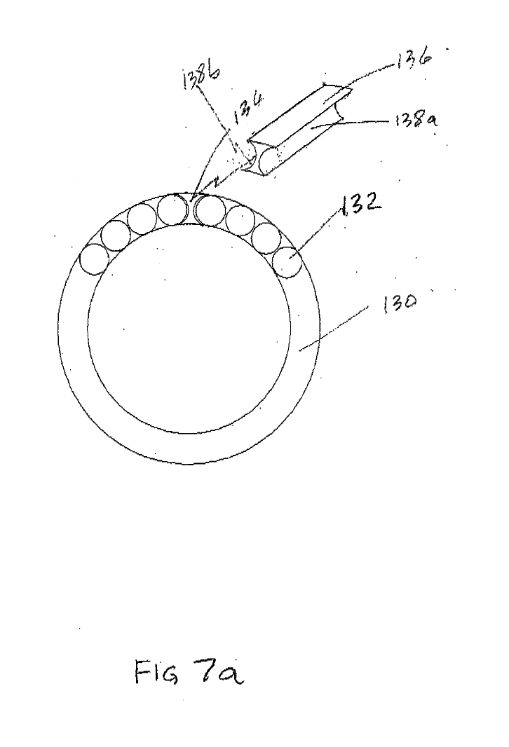

FIG. 7 shows a section of a ball bearing row 120 with balls 122 and non bearing element lubricating spacer 124 between selected balls. The lubricating element shown at 126 is made of a plastic such as Teflon which rubs against balls 122 during use, leaving a coating of lubricating plastic on balls 122 and race 120. Element 126 is shaped to fit in race 120 and has opposing concavities 128a and 128b to provide the maximum of contact area and the minimum of space between balls 122, such that bearing loads are not significantly increased.

FIG. 7a shows a cross section of a roller bearing row 130 with balls 132 and cross section of lubricating element 134 between selected rollers. The element shown at 136 is made of a plastic such as Teflon which rubs against rollers 132 during use, leaving a coating of lubricating plastic on rollers 132 and race 130. Element 136 is shaped to fit in race 130 and has opposing concavities 138a and 138b to provide the maximum of contact area and the minimum of space between rollers 132, such that bearing loads are not significantly increased.

This lubrication of balls and rollers reduces both wear as well as friction and hence increases the efficiency of the bearing.

It should be understood that the concepts disclosed are not meant to be complete or define a particular model or limit the concept or application in any way.

Whilst it is preferred to utilize ball bearings for the taking of axial and radial loads it is within the scope of the invention to utilize relatively short plain, non tapered, roller bearings between substantially parallel bearing faces. Whilst this results in some scrubbing, if the angle to the rotational axis is no more than about 30 degrees and the rollers are not too long, the amount of scrubbing is acceptable.

From the foregoing it should be readily evident that there has been provided a significantly improved, simple, lightweight, high load block assembly which is more efficient.

The features of the invention described or otherwise disclosed in the text and drawings may be combined in any combination of features where such features are not mutually exclusive.

### INDUSTRIAL APPLICABILITY

The invention has industrial applicability to blocks.

1. A block having a sheave mounted for rotation about an axis on a first race, the sheave having a sheave race and a peripheral circumferentially extending groove for receiving a flexible tension member, the sheave having a sheave width and the groove having a groove width, the sheave race including
two spaced apart first surfaces that engage first rolling elements located between the sheave race and corresponding second surfaces on the first race
and at least one third surface that engages second rolling elements located between the sheave race and corresponding fourth surfaces the first race, wherein
A. the first and second surfaces are shaped so the first rolling elements transfer both axial and radial loads between the sheave race and the first race, and the third and fourth surfaces are shaped so the second rolling elements transfer radial loads between the sheave race and the first race,
or
B. the ratio of:
B1)sheave width to groove depth is more than about 2.5:1, or
B2)sheave diameter to sheave width is less than about or equal to 3.2:1, or
B3)the ratio of sheave width to groove depth is more than about 2.5:1 and the ratio of sheave diameter to sheave width is less than about or equal to 3.2:1,
or
C. the first and second surfaces are shaped so the first rolling elements transfer at least axial loads between the sheave race and the first race, and the third and fourth surfaces are shaped so the second rolling elements transfer radial loads between the sheave race and the first race, and
the ratio of:
C1) sheave width to groove depth is more than about 2.5:1, or
C2) sheave diameter to sheave width is less than about or equal to 3.2:1, or
C3) the ratio of sheave width to groove depth is more than about 2.5:1 and the ratio of sheave diameter to sheave width is less than about or equal to 3.2:1.

2. The block of claim 1 wherein the at least one first surface includes a first portion extending generally parallel to the axis and a second portion extending generally perpendicular to the axis.

3. The block of claim 2 to wherein the second portion extends radially inwards from the first portion.

4. The block of claim 2 wherein the second portion extends radially outwards from the first portion.

5. The block of claim 1 wherein the third surface includes a third portion extending generally parallel to the axis.

6. The block of claim 1 wherein the third surface is located between the two first surfaces.

7. The block of claim 1 wherein at least one line extending perpendicular to the axis passes through the third surface and a first surface.

8. The block of claim 1 wherein the third portion has a width substantially equal to the sheave width.

9. The block of claim 1 wherein the first and second surfaces are contiguous.

10. The block of claim 1 wherein the third portion is located radially inwards compared to a first portion.

11. The block of claim 1 wherein the second rolling elements are located radially inwards compared to the first rolling elements.

12. The block of claim 1 wherein the second rolling elements include at least two parallel sets of rolling elements.

13. The block of claim 1 wherein the first rolling elements are located substantially within the groove width.

14. The block of claim 1 wherein the first rolling elements extend significantly beyond the groove width.

15. The block of claim 1 wherein the first rolling elements are located substantially outside the groove width.

16. The block of claim 1 wherein the first rolling elements comprise ball bearings or non tapered roller bearings.

17. The block of claim 1 wherein the second rolling elements comprise ball bearings, roller bearings or both ball bearings and roller bearings.

18. The block of claim 1 wherein the at least one first surface and corresponding second surface comprise parallel surfaces extending at an angle to the axis.

19. The block of claim 1 wherein the ratio of sheave width to groove depth is greater or equal to about 4:1

20. The block of claim 1 wherein the second rolling elements comprise a single line of non tapered roller bearings.

21. The block of claim 1 wherein the second rolling elements comprise a single line of non tapered roller bearings, each of which has a length substantially the same as the sheave width.

22. The block of claim 1 wherein the first and second surfaces are shaped so the first rolling elements only transfer radial loads between the sheave race and the first race.

23. The block of claim 1 wherein the first and second surfaces are shaped so the first rolling elements transfer both axial and radial loads between the sheave race and the first race.

24. The block of claim 1 wherein the third and fourth surfaces are shaped so the second rolling elements only transfer radial loads between the sheave race and the first race.

25. The block of claim 1 wherein the sheave has a single groove.

26. The block of claim 1 having a single sheave.
